(19) United States
(12) Patent Application Publication
(10) Pub. No.: US 2010/0199820 A1
(43) Pub. Date: Aug. 12, 2010

(54) METHOD OF PROCESSING TUBES

(76) Inventor: John QUIGLEY, Nashua, NH (US)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/367,801

(22) Filed: Feb. 9, 2009

(51) Int. Cl. B26D 7/06; B23D 21/04

(52) U.S. Cl. 83/27; 83/183

(57) ABSTRACT

When a tube is to be cut into a plurality of sections, the tube and the mandrel are moved into a telescopic relationship. The tube is cut to form a plurality of product sections and at least one scrap section while the tube and mandrel rotate about a central axis of the mandrel. The scrap section is gripped while the scrap section and mandrel are in a telescopic relationship. The mandrel and scrap section are moved out of the telescopic relationship while continuing to grip the scrap section. The product sections are received at a receiving location. Scrap sections may be formed at opposite end portions of the tube and gripped by first and second grippers. Backup rollers may be pressed against the tube during cutting of the tube.

### BACKGROUND OF THE INVENTION

The present invention relates to a new and improved method and apparatus for use in processing tubes. More specifically, the invention relates to the cutting of a tube into a plurality of sections.

A known apparatus for cutting a tube into a plurality of sections includes a feed ramp along which tubes move to a work station. Once a tube is moved to the work station, a mandrel is extended into a telescopic relationship with the tube. A mandrel drive assembly is effective to rotate the mandrel and the tube. While the mandrel and tube are rotating, a plurality of annular rotating knives are moved into engagement with the tube to cut the tube into a plurality of sections.

Once the tube has been cut into a plurality of sections with this known apparatus, the annular knives are moved out of engagement with the tube and the mandrel is retracted. Retracting of the mandrel results in the sections of the tube dropping downward to a receiving location. An apparatus having this construction and mode of operation is disclosed in U.S. Pat. No. 5,214,988. Another apparatus for use in cutting a tube into a plurality of sections is disclosed in U.S. Patent Publication No. 2004/0163512 published on Aug. 26, 2004.

Problems may be encountered in removing scrap waste pieces from a tube cutting operation using some known tube cutting systems. These known systems may include a significant manual inspection in the process. This is costly and time-consuming considering the millions and millions of cut tubes that are processed every day in this country alone.

One possible reason for this is because some known tube cutting systems used with machines having mandrels which do not move axially, strip their tubes axially from a mandrel. This requires a movable stripper to eject the cut pieces, including the scrap pieces, laterally off the open end of the mandrel. When all the cut tubes are rapidly moving laterally into free space difficulty may be encountered in separating the useable tubes from the scrap ends.

### SUMMARY OF THE INVENTION

The present invention relates to a new and improved method and apparatus for processing tubes. When a tube is to be processed, the tube is moved into a work station. The tube is cut into a plurality of sections while the tube is at the work station.

The sections into which the tube is cut may include one or more scrap sections. The scrap section or sections may advantageously be moved to a scrap receiving location or locations. Other sections of the tube, that is, product sections, may be moved to a product receiving location which is separate from a scrap receiving location.

In accordance with one of the features of the invention, a scrap section may be gripped with a gripper. This may be done while the scrap section and mandrel are in a telescopic relationship. Thereafter, the mandrel and scrap section are moved out of a telescopic relationship. The scrap section may be moved away from the mandrel along a path which extends transverse to a central axis of the mandrel while continuing to grip the scrap section.

In accordance with another feature of the invention, before the tube is cut, the tube may be supported at the work station by one or more grippers. After the tube is cut, a scrap section of the tube may be gripped with a gripper while the mandrel is in a telescopic relationship with the scrap section. The scrap section and gripper may be moved away from the work station after the scrap section and mandrel have moved out of the telescopic relationship.

In accordance with another feature of the invention, when a second tube is moved to the work station and is cut to form a plurality of product sections and one or more scrap sections, a gripper may be moved toward a scrap section formed by the second tube while the gripper holds a scrap section formed by the first tube. The scrap section formed by the first tube may be moved relative to the gripper as the gripper moves toward the scrap section formed by the second tube. The scrap section formed by the second tube may be gripped by the gripper and moved away from the mandrel while the gripper holds the scrap section formed by the first tube.

The present invention includes the foregoing and other features which will be described in combination with each other. However, it is contemplated that each of the features may be utilized separately or may be combined in a different manner with one or more of the other features of the invention. It is also contemplated that one or more of the features of the invention may be used separately or in combination with features from the prior art.

### BRIEF DESCRIPTION OF THE DRAWINGS

The foregoing and other features of the invention will become more apparent upon a consideration of the following description taken in connection with the accompanying drawings wherein:

FIG. 1 is a schematic pictorial illustration of an apparatus constructed in accordance with the present invention to process tubes in accordance with a method of the present invention;

FIG. 2 is a schematic top plan view of the apparatus of FIG. 1 and illustrating the relationship between a tube supply apparatus, a mandrel, and a plurality of knives;

FIG. 3 is a schematic end view, taken generally along the line 3-3, of FIG. 2, further illustrating the construction of the tube processing apparatus of FIG. 1;

FIG. 4 is a schematic pictorial illustration of a left gripper assembly used in the tube processing apparatus of FIG. 1;

FIG. 5 is a schematic pictorial illustration, taken generally along the line 5-5 of FIG. 4, further illustrating the construction of the left gripper assembly;

FIG. 6 is a fragmentary schematic pictorial illustration, generally similar to FIG. 4, illustrating the construction of a right gripper assembly used in the tube processing apparatus of FIGS. 1-3;

FIG. 7 is a fragmentary schematic pictorial illustration depicting the construction of an apparatus which moves a plurality of backup rollers into engagement with a tube disposed at a work station in the tube processing apparatus of FIG. 1;

FIG. 8 is a schematic illustration depicting the relationship between a tube supply apparatus, mandrel, tube cutter, scrap section grippers, and tube backup rollers in the tube processing apparatus of FIGS. 1-3 prior to movement of a tube to a work station;

FIG. 9 is a schematic illustration, generally similar to FIG. 8, depicting the manner in which a tube is received at the work station;

FIG. 10 is a schematic illustration, generally similar to FIGS. 8 and 9, depicting the manner in which a mandrel is moved into a telescopic relationship with a tube at the work station;

FIG. 11 is a schematic illustration, generally similar to FIGS. 8-10, depicting the manner in which the backup rollers engage a tube and the manner in which a plurality of knives cut the tube;

FIG. 12 is a schematic illustration generally similar to FIGS. 8-11, depicting the manner in which a mandrel is moved out of a telescopic relationship with a tube and the manner in which grippers grip scrap sections formed at opposite end portions of the tube;

FIG. 13 is a schematic illustration, generally similar to FIGS. 8-12, depicting the manner in which the grippers are moved away from the work station while gripping scrap sections of a tube;

FIG. 14 is a schematic illustration depicting the relationship of a plurality of scrap sections to one of the grippers, the gripper being illustrated in a closed condition gripping a plurality of scrap sections;

FIG. 15 is a schematic illustration, generally similar to FIG. 14, depicting the relationship between the gripper and the scrap sections when the gripper is in an open condition;

FIG. 16 is a schematic illustration, generally similar to FIG. 15, depicting the manner in which scrap sections are moved relative to the gripper by engagement of a scrap section with a portion of a tube disposed in a telescopic relationship with the mandrel; and

FIG. 17 Is a fragmentary pictorial illustration of the tube processing apparatus of FIG. 1, with a tube cutter assembly removed.

### DESCRIPTION OF SPECIFIC PREFERRED EMBODIMENTS OF THE INVENTION

### General Description

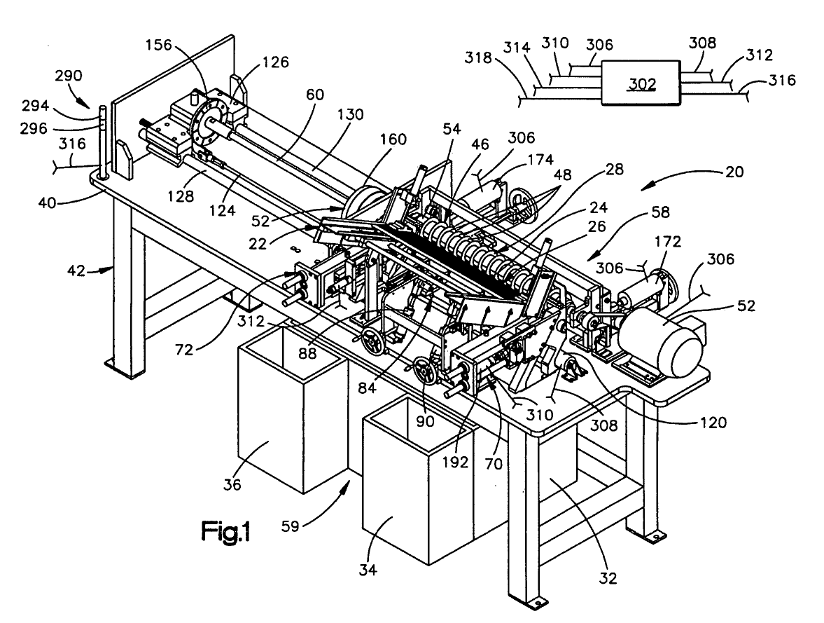

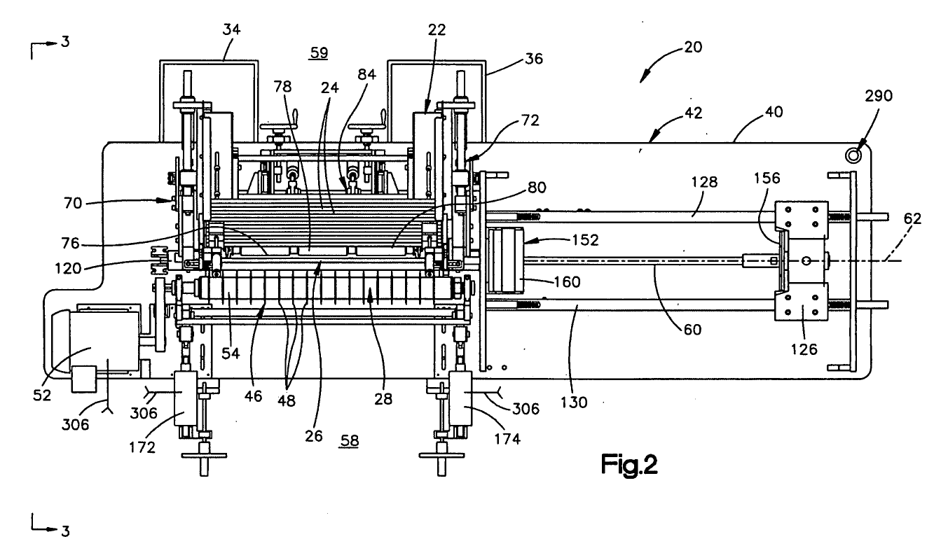

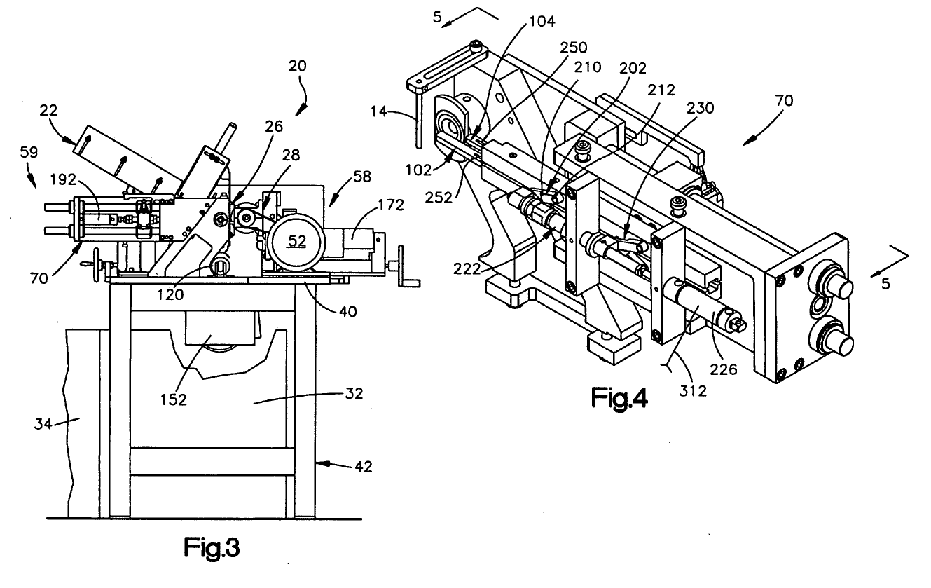

A tube processing apparatus 20 constructed and operated in accordance with the present invention is illustrated in FIGS. 1-3. The tube processing apparatus 20 includes a tube feed or supply assembly 22 which is operable to feed hollow cylindrical tubes 24 (FIG. 2) one at a time to a work station 26. The tubes 24 may be formed of paper, polymeric material, or any other desired material.

A known tube cutter assembly 28 cuts a tube 24 disposed at the work station 26 into a plurality of cylindrical sections. The sections of the tube 24 move to receiving locations 32, 34, and 36 (FIG. 1). The illustrated receiving locations are containers having open upper ends. The receiving locations include a product receiving location 32 where product sections of a tube cut at the work station 26 are received. The receiving locations 34 and 36 receive scrap sections of the tube.

Tape, ribbon, paper or other materials may subsequently be wound around the product sections which have been removed from the product section receiving location 32. It is contemplated that the product sections of the tube 24 will be used for many different purposes, such as spacers or insulating layers. The scrap sections of the tube may be removed from the receiving locations 34 and 36 and recycled or disposed of in a suitable manner.

Scrap sections are formed by end portions of the tubes 24. When more than one scrap section is to be formed from one of the tubes 24, the scrap sections may be disposed at axially opposite ends of each tube. The scrap sections are received at scrap receiving locations 34 and 36 which are spaced apart from the product receiving location 32.

It is desirable to keep the scrap sections separate from the product sections. This is because it is difficult to separate scrap sections from product sections. When the product sections of a tube 24 are used in a machine which winds material around the product sections, the machine may be caused to malfunction by a scrap section. This is because the scrap sections have a different axial length than the product sections.

Customers that purchase cut tubes for use in their various products are increasingly employing automatic tube (core) handling machinery to handle large volumes of cut tubes used in numerous operations. These automatic tube-handling machines have no tolerance for cut tubes or, cores that are not of a consistent size. It causes serious problems if the scrap pieces are mixed with the good pieces. Scrap pieces almost always have an axial dimension that is different than the good, or usable tubes as well as one end that is rough cut due to an initial saw cutting operation that is done before the original tubes are processed by the tube cutter. The rough-cut end(s) of the scrap pieces are not acceptable even if the axial dimensions of the scrap pieces happen, by chance or design, to match the axial dimensions of the good pieces.

In the embodiment of the tube processing apparatus 20 illustrated in FIG. 1, the product receiving location 32 is disposed beneath a top 40 of a base 42. The tube cutter assembly 28 and tube feed assembly 22 are both supported on the top 40 of the base 42. Product sections cut from the tubes 24 fall downwardly, under the influence of gravity, into the product section receiving location 32 disposed in a container located beneath the top 40. However, if desired, the product section receiving location 32 may be disposed at a different location, for example, a location which is remote from the base 42.

Similarly, the scrap section receiving locations 34 and 36 are disposed adjacent to and below the top 40. However, the scrap receiving location containers 34 and 36 may be disposed at a location which is spaced from the base 42. If desired, the two scrap receiving locations 34 and 36 may be combined into a single scrap receiving location. Of course, if only one scrap section is formed from a tube 24, there may be only one scrap receiving location. If one or more of the receiving locations 32, 34 and/or 36 are disposed at a location which is remote from the base 42, a suitable conveyor or conveyors would be provided to conduct the appropriate cut sections to the appropriate receiving location.

The tube cutter assembly 28 has a known construction and includes a linear array 46 (FIGS. 1 and 2) of annular knives 48. A knife drive motor 52 (FIGS. 1-3) is connected with a spindle or arbor 54 on which the annular knives 48 are mounted. The knife drive motor 52 is operable to rotate the arbor 54 and annular knives 48 about a longitudinal central axis which extends through the center of each of the rotatable knives. The tube cutter assembly 28 may have a construction which is different than the illustrated construction.

The annular knives 48 are spaced apart along the central axis of the spindle 54 by a distance which corresponds to the desired length (axial extent) of the cylindrical sections to be cut from a tube 24. For example, if the tube 24 is to be cut into cylindrical sections having an axial length of one inch, the knives 48 would be spaced apart by a distance of one inch along the coincident longitudinal central axes of the linear array 46 and spindle 54. Of course, the distance between the knives 48 may be adjusted to enable a tube 24 to be cut into cylindrical sections of any desired axial extent. It should be understood that a greater or lesser number of knives 48 may be provided to cut a tube 24 into a greater or lesser number of cylindrical sections.

During cutting of a tube 24 into a plurality of sections, an individual who is operating the apparatus 20 may be disposed at cutting side station 58 or a supply station 59 (FIGS. 1 and 2). At this time, a tube 24 is supported by a cylindrical mandrel 60 (FIGS. 1 and 2). The cylindrical mandrel 60 is telescopically received in and extends through a tube 24 disposed at the work station 26. The mandrel 60 supports and rotates the tube 24 during cutting of the tube by the knives 42. This results in the rotating mandrel 60 being disposed in a telescopic relationship with each of the sections which are formed by cutting the tube with the annular knives 48.

The cylindrical mandrel 60 has a longitudinal central axis 62 (FIG. 2) which extends parallel to a longitudinal central axis of the linear array 46 of knives 48. During cutting of a tube 24 with the knives 48, the knives are rotated by the knife drive motor 52. The central axis 62 of the mandrel 60 is coincident with a central axis of a tube 24 being cut with the knives 48. The tube 24 being cut by the knives 48 is rotated with the mandrel 60 about the coincident central axes of the mandrel and the tube.

The manner in which a tube 24 is supported by and rotated with the mandrel 60 during cutting of the tube into a plurality of sections is similar to the manner in which U.S. Pat. No. 5,214,988 discloses that tubes are to be cut. The disclosure in the aforementioned U.S. Pat. No. 5,214,988 is hereby incorporated herein in its entirety by this reference thereto. The manner in which cut sections of a tube 24 are supported by the mandrel 60 and rotated by the mandrel is similar to the disclosure in the United States Patent Application Publication 2004/0163512, published Aug. 26, 2004. The disclosure in the aforementioned United States Patent Application Publication 2004/0163512 is hereby incorporated herein in its entirety by this reference thereto.

In accordance with one of the features of the present invention, left and right, as viewed from the cutting side station 58, gripper assemblies 70 and 72 (FIGS. 1-6) are provided in the tube processing apparatus 20. The gripper assemblies 70 and 72 grip scrap sections of a tube at the work station 26 while the scrap sections of the tube are disposed in a telescopic relationship with the mandrel 60. The terms left and right, as used herein, are to be considered a being taken from the point of view of an operator disposed at the cutting side station 58. It should be understood that if only one scrap section is to be formed during cutting of a tube 24, there would be only one gripper assembly. Of course, the apparatus 20 may be provided with two gripper assemblies 70 and 72, with one of the gripper assemblies being maintained in an inactive condition during forming of only one scrap section from a tube 24.

After the mandrel 60 has been withdrawn from the scrap sections of a tube, the left and right gripper assemblies 70 and 72 continue to grip the scrap sections. The left and right gripper assemblies 70 and 72 then move the scrap sections away from the work station 26. The gripper assemblies 70 and 72 move the scrap sections away from the work station 26 along paths which extend transverse to the central axis 62 of the mandrel 60. In the illustrated embodiment of the invention, the gripper assemblies 70 and 72 move scrap sections away from the work station 26 along paths which extend perpendicular to the central axis 62 of the mandrel 60.

The scrap sections move from the left and right gripper assemblies 70 and 72 into the scrap receiving locations 34 and 36. Thus, a scrap section is moved away from the work station 26 by the left gripper assembly 70 and is received at the left scrap receiving location 34. Similarly, a scrap section is moved away from the work station 26 by the right gripper assembly 72 and is received at the right scrap receiving location 36. Baffle plates are provided to maintain the scrap sections in alignment with the gripper assemblies 70 and 72 and to direct the scrap sections to the scrap receiving locations 34 and 36. It is contemplated that the number of gripper assemblies and the number of scrap receiving locations will correspond to the number of scrap sections formed during cutting of a tube 24. However, scrap sections engaged by the left and right gripper assemblies 70 and 72 may both be moved to a single container at one receiving location.

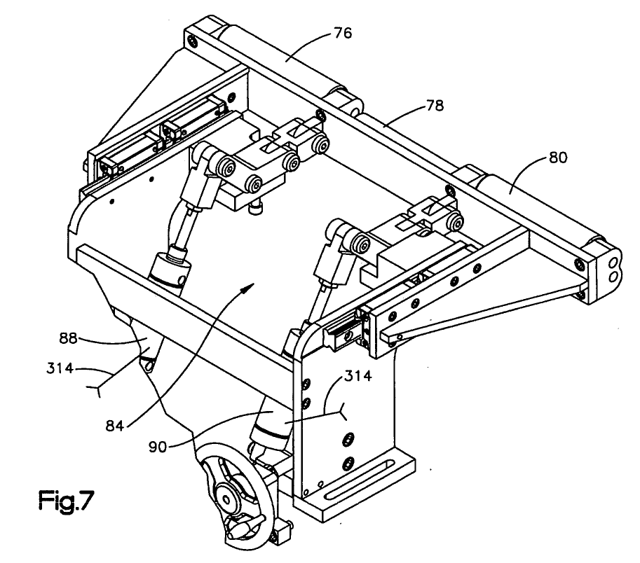

In accordance with another one of the features of the present invention, a plurality of backup rollers 76, 78, and 80 (FIGS. 2 and 7) are provided to backup or partially support a tube 24 being cut at the work station 26. The cylindrical backup rollers 76-80 engage the outer side surface of the tube at the work station 26 and are rotated about their longitudinal central axes by force transmitted from the tube 24 at the work station 26. The backup rollers 76-80 have central axes which are parallel to the central axis 62 of the mandrel 60.

The tube 24 at the work station 26 is itself rotated by force transmitted from the mandrel 60 to the tube. Therefore, the force which rotates the backup rollers 76-80 about their longitudinal central axis is transmitted from the mandrel 60 through the tube 24 at the work station 26 to the backup rollers. Of course, the backup rollers 76-80 could be driven in a different manner if desired. For example, a separate drive could be provided for the backup rollers 76-80.

The backup rollers 76-80 are pressed against the tube 24 as the tube is cut by the annular knives 48. An over-center linkage assembly 84 is provided to hold the rollers 76-80 in firm engagement with a cylindrical outer side surface of a tube 24 being cut by the knives 48 at the work station 26. The over-center linkage assembly 84 has a toggle action and is operable from the engaged over-center condition illustrated in FIG. 7 to a release or unlocked condition by motors 88 and 90. The over-center linkage assembly 84 has a known toggle action which is similar to the toggle action of the over-center linkage assemblies disclosed in U.S. Pat. Nos. 5,426,990 and 5,921,535.

It is contemplated that the backup rollers 76-80 and/or over-center linkage assembly 84 may be omitted from the apparatus 20 if desired. However, the support provided by the backup rollers 76-80 may be considered advantageous when the tubes 24 are relatively long and/or have relatively small inside diameters. In addition, the backup rollers 76-80 help to insure that sections of the tube 24 are completely cut through and are easily separable from each other.

### Operation

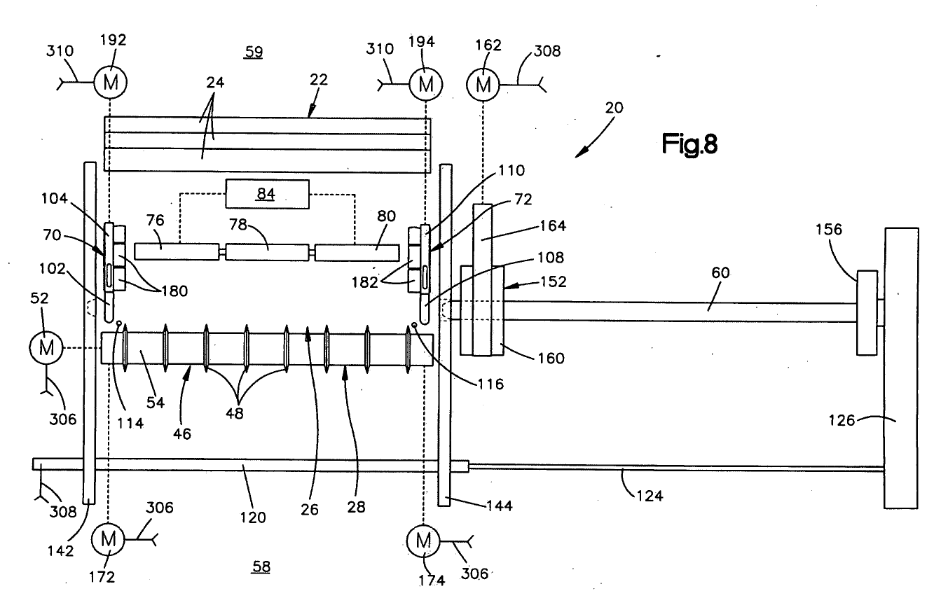

The tube processing apparatus 20 is schematically illustrated in FIG. 8 in an initial condition before initiation of tube cutting operations. At this time, the tubes 24 are disposed in a side-by-side relationship in the tube feed or supply assembly 22 (FIGS. 1-3). A tube 24 has not yet moved into the work station 26 (FIG. 8). The mandrel 60 is in a retracted or withdrawn condition in which the mandrel is spaced from the work station 26. The tube cutter assembly 28 is also in a retracted condition.

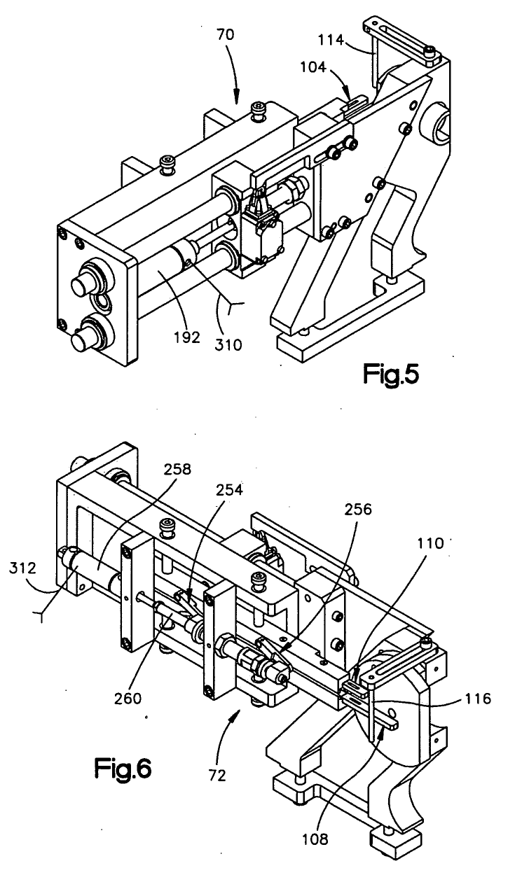

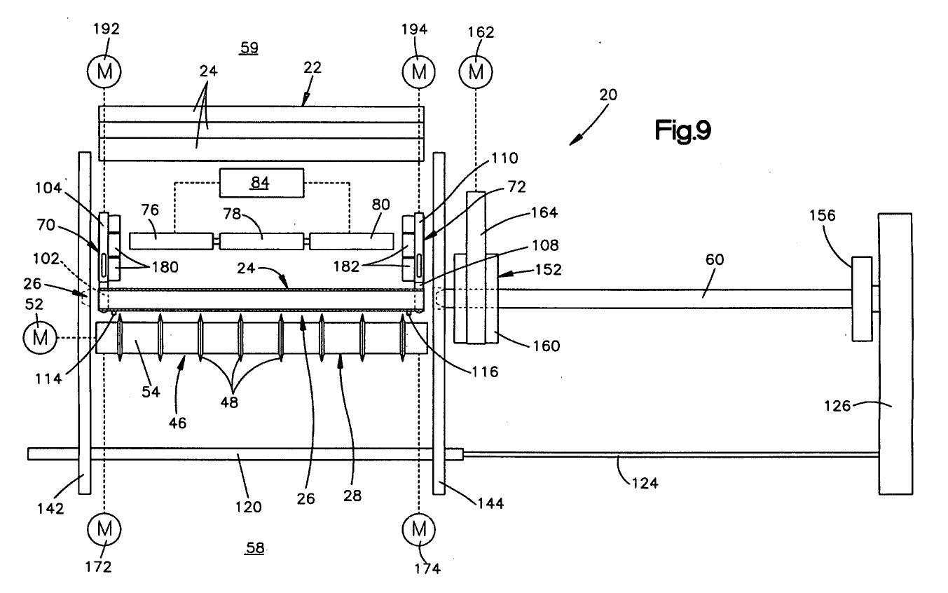

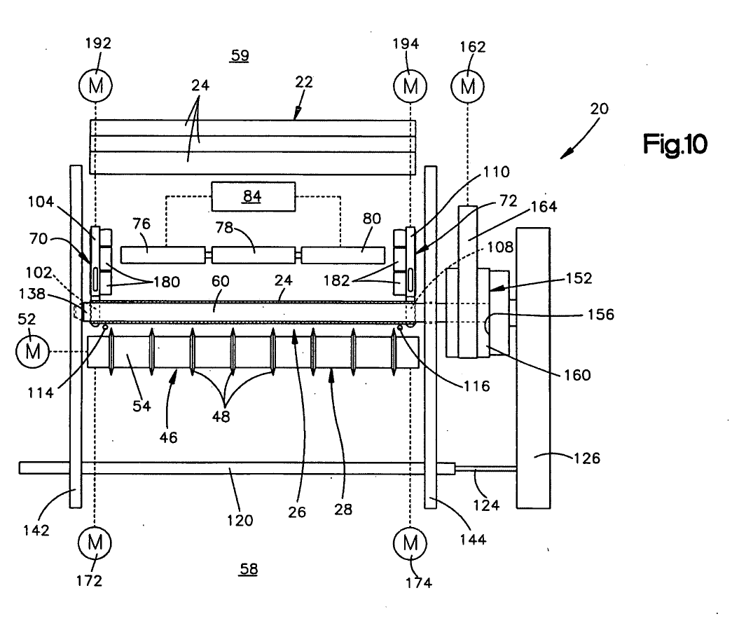

When a tube cutting operation is to be undertaken, a first cylindrical tube 24 is fed from the tube supply assembly 22 to the work station 26 in the manner illustrated schematically in FIG. 9. At this time, the cylindrical mandrel 60 is spaced from the work station 26 and the tube 24 is supported by engagement with left and right gripper assemblies 70 and 72. The left gripper assembly 70 (FIG. 4) includes a relatively long lower gripper finger 102 and a shorter upper gripper finger 104. Similarly, the right gripper assembly 72 (FIG. 6) includes a relatively long lower gripper finger 108 and a relatively short upper gripper finger 110.

The use of the gripper assemblies 70 and 72 to support a tube 24 at the work station 26 is currently believed to be one of the advantageous features of the invention. However, it is contemplated that the tubes 24 may be supported at the work station 26 in a different manner if desired. For example, suitable brackets may be provided at the work station 26 to support a tube 24. When the apparatus 20 is to be used to form only one scrap section from a tube 24, one of the gripper assemblies 70 or 72 may be omitted and a bracket used in association with the remaining gripper assembly to support a tube. Alternatively, one of the gripper assemblies 70 or 72 may be in an inactive condition in which it can be used to support a tube 24 and is not to be used to grip a portion of the tube.

As a tube 24 (FIG. 9) moves into the work station 26, the tube engages a left (as viewed from the cutting side station 58) stop pin 114 adjacent the left gripper assembly 70 (FIGS. 4 and 5). Contemporaneously therewith, the tube 24 engages a right stop pin 116 adjacent the right gripper assembly 72 (FIG. 6). When the tube 24 is in engagement with the stop pins 114 and 116, (FIG. 9) the tube 24 is disposed at the work station 26. The stop pins 114 and 116 are cylindrical and have central axes which extend perpendicular to the central axis 62 of the mandrel 60.

The tube 24 then moves downward along the stop pins 114 and 116 into engagement with the relatively long lower gripper fingers 102 and 108 (FIG. 9) of the left and right gripper assemblies 70 and 72. The tube 24 engages and is supported on the lower gripper fingers 102 and 108. The tube 24 is also in engagement with the stop pins 114 and 116. A longitudinal central axis of the tube 24 is disposed just slightly below and parallel to the longitudinal central axis 62 of the mandrel 60. Other than being slightly below the axis 62 of the mandrel 60, the longitudinal central axis of the tube 24 disposed at the work station 26 is in alignment with the longitudinal central axis 62 of the mandrel 60.

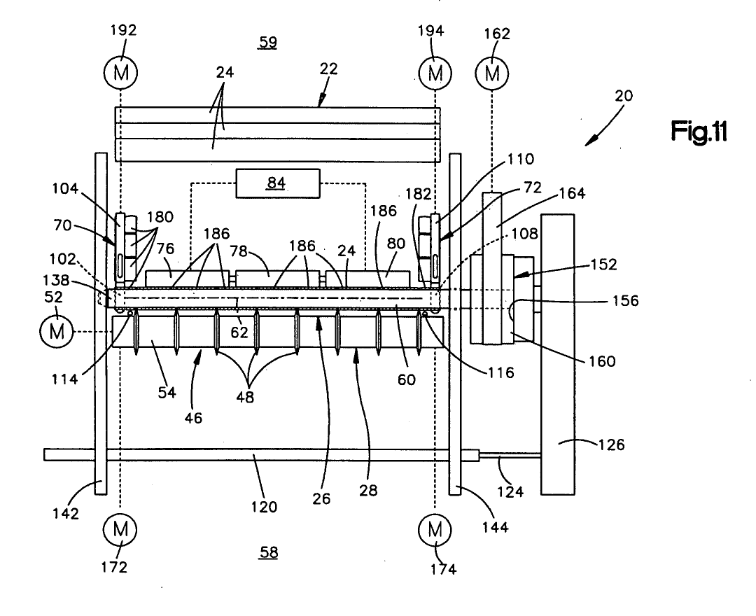

The mandrel 60 is then moved from the retracted position of FIG. 9 to the extended position of FIG. 10 by a piston and cylinder type mandrel motor 120. The pneumatically actuated mandrel motor 120 has a piston rod 124 which is connected with a mandrel slide block 126. The mandrel slide block 126 is movable along a pair of parallel guide rails 128 and 130 (FIGS. 1 and 2) upon operation of the mandrel motor 120 (FIGS. 9 and 10).

When the piston and cylinder type mandrel motor 120 is in the extended condition of FIG. 9, the mandrel 60 is retracted to the right (as viewed in FIG. 9) of the work station 26. As was previously mentioned, the tube 24 is disposed at the work station 26 in substantial alignment with the mandrel 60. However, the central axis of the tube 24 is slightly below and parallel to the central axis 62 of the mandrel.

The mandrel motor 120 is then operated from the extended condition of FIG. 9 to the retracted condition of FIG. 10. This causes the mandrel 60 to move toward the left (as viewed in FIG. 2) along the guide rails 128 and 130 from the retracted position (FIG. 9) to the extended position illustrated schematically in FIG. 10. As this occurs, a tapered leading end portion 138 (FIG. 10) of the mandrel 60 enters the right (as viewed in FIG. 9) end portion of the hollow tube 24. The mandrel 60 then slides lengthwise along a cylindrical inner surface of the tube 24 to obtain a telescopic relationship with the tube (FIG. 10). As this occurs, the tube 24 is raised slightly so that the central axes of the mandrel 60 and tube 24 are coincident.

The tapered leading end portion 138 (FIG. 10) of the mandrel 60 enters a socket disposed on a left side plate 142 of the tube positioning apparatus 20. The left side plate 142 rotatably supports the tapered leading or left end portion 138 of the retracted mandrel 60. Suitable bearings (not shown) are provided on the left side plate 142 to facilitate rotation of the mandrel 60.

A right side plate 144 of the tube processing apparatus 20 supports a stripper plate. The right side plate 144 has an opening through which the mandrel 60 extends. The right end portion of the mandrel is rotatably supported by the slide block 126 and guide rails 128 and 130. If desired, suitable bearing may be provided on the right side plate 144 to further support the mandrel 60.

As the mandrel 60 moves into a telescopic relationship with the tube 24 at the work station 26 (FIG. 10), the tube is lifted a short distance upwardly by the mandrel 60. This results in an establishment of a small gap between the peripheral surface of the tube 24 and the lower gripper fingers 102 and 108. If desired, the tube 24 may be axially aligned with the mandrel 60 so that the peripheral surface of the tube 24 remains in engagement with the lower gripper fingers 102 and 108 when a telescopic relationship has been established between the mandrel 60 and tube 24.

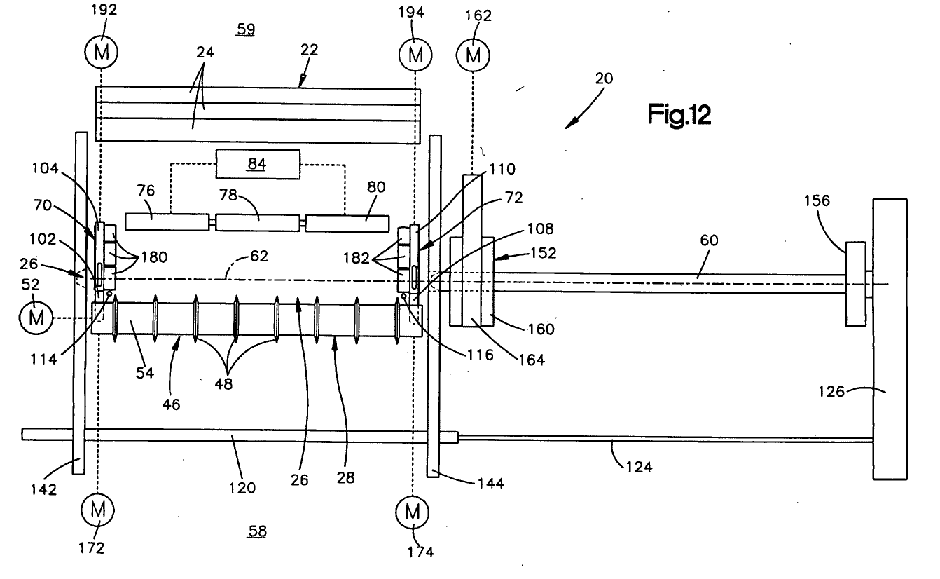

The mandrel 60 is rotated about its longitudinal central axis by a mandrel drive assembly 152 when the mandrel is disposed in a telescopic relationship with the tube 24 (FIG. 10). During movement of the mandrel 60 from the extended position of FIGS. 8 and 9 to the retracted position of FIGS. 10 and 11, the mandrel drive assembly 152 is ineffective provide force to rotate the mandrel 60. However, the mandrel 60 may rotate under the influence of its own inertia during movement of the mandrel from the extended position to the retracted position.

The mandrel drive assembly 152 includes a clutch plate 156 (FIGS. 1 and 2) which is fixedly connected with the mandrel. The clutch plate 156 is deposed in a coaxial relationship with the mandrel 60. When the mandrel is in the extended position of FIGS. 1, 2, 8, and 9 the clutch plate 156 is axially spaced from a mandrel drive pulley 160. Therefore, at this time, the mandrel drive pulley 160 is ineffective to rotate a clutch plate 156 connected to the mandrel 60.

Upon operation of the mandrel motor 120 and movement of the mandrel 60 from the extended position of FIGS. 8 and 9 to the retracted position of FIGS. 10 and 11, the clutch plate 156 moves into engagement with the mandrel drive pulley 160. The mandrel drive pulley 160 is coaxial with the clutch plate 156 and mandrel 60. The mandrel drive pulley 160 is continuously rotated by a motor 162 through a drive belt 164. Since the clutch plate 156 is fixedly secured to the mandrel 60, engagement of the clutch plate 156 with the mandrel drive pulley 160 is effective to rotate the mandrel 60 about its longitudinal central axis 62. The manner in which the mandrel 60 is driven by engagement of the clutch plate 156 with the mandrel drive pulley 160 is the same as is disclosed in the aforementioned U.S. Pat. No. 5,214,988 which has been and hereby is incorporated herein in its entirety.

When the mandrel 60 reaches the retracted position illustrated schematically in FIG. 10, the mandrel is rotatably driven by the mandrel drive assembly 152. At this time, the tube 24 is in a telescopic relationship with the mandrel 60. The mandrel 60 and tube 24 are rotated together about the central axis 62 of the mandrel by the mandrel drive assembly 152. The mandrel 60 and tube 24 are rotatably supported by suitable bearing assemblies mounted on the side plates 142 and 144.

Once the tube 24 and mandrel 60 are disposed in a telescopic relationship, as illustrated in FIG. 10, the over-center linkage assembly 84 is operated to move the cylindrical backup rollers 76, 78 and 80 from the retracted condition illustrated in FIG. 10 to the engaged condition illustrated in FIG. 11. When the backup rollers 76, 78, and 80 are in the retracted condition of FIG. 10, the backup rollers are spaced from the cylindrical peripheral outer surface of the tube 24. When the backup roller 76, 78 and 80 are in the engaged condition of FIG. 11, cylindrical peripheral surfaces of backup rollers 76, 78, and 80 are disposed in engagement with the peripheral surface of the tube 24.

The central axes of the backup rollers 76, 78 and 80 extend parallel to the coincident central axes of the tube 24 and mandrel 60. However, the central axes of the backup rollers 76 and 78 are offset slightly upward of the central axis 62 of the mandrel 60. The central axis of the backup roller 78 is disposed slightly below the central axis 62 of the mandrel 60. The amount by which the central axis of the backup roller 78 is disposed below the central axis 62 of the mandrel 60 is the same as the amount by which the central axis of the backup rollers 76 and 80 are disposed above the central axis 62 of the mandrel 60.

The backup rollers 76, 78 and 80 are rotated about their parallel central axes under the influence of force transmitted from the tube 24 to the backup rollers 24. The tube 24 is, itself, rotated by force transmitted from the mandrel drive assembly 152 through the mandrel 60 to the tube. At this time, the backup rollers 76, 78 and 80 are firmly pressed against the peripheral surface of the tube 24 by the over-center linkage assembly 84. As was previously mentioned, the backup rollers 76, 78 and 80 may be rotated by a separate drive arrangement.

After the backup roller 76, 78 and 80 have been moved into position (FIG. 11), the tube cutter assembly 28 is moved toward the mandrel 60 by motors 172 and 174 (FIGS. 10 and 11). As the motors 172 and 174 are operated to advance the tube cutter assembly 28 toward the tube 24, the longitudinal central axis of the spindle 54, on which the annular knife blades 48 are disposed, is maintained parallel to the longitudinal central axis 62 of the mandrel 60. The backup rollers 76, 78 and 80 provide radial support for the tube 24 and mandrel 60. This prevents radial deflection of the tube 24 and mandrel 60 under the influence of forces transmitted from the knives 48.

As the tube cutter assembly 28 is advanced from the retracted position of FIG. 10 to the cutting position of FIG. 11, the spindle 54 and knives 48 are rotated by the drive motor 52. This results in the knives 48 cutting the tube 24 as the knives move into engagement with the tube. As the knives 48 cut the tube 24, force is transmitted from the knives through the tube 24 and spindle 60 to the backup rollers 76, 78 and 80 to prevent deflection of the mandrel 60 and tube 24 during cutting of the tube. This support enables the knives to cut completely through the side wall of the tube so that the sections of the tube are easily separated.

The linear array 46 of knives 48 is effective to cut the tube 24 into a plurality of sections. The cylindrical sections are disposed in a coaxial relationship with each other and are disposed in a telescopic relationship with the mandrel 60. Relatively short scrap sections 180 and 182 are formed at axially opposite end portions of the tube 24. Uniform product sections 186 are formed between knives 48 in the linear array 46 of knives.

Since the knives 48 are spaced equal distances apart along the spindle 54, the product sections 186 all have the same length or extent along the longitudinal central axis of the mandrel 60. If desired, the distance between the knives 48 may vary so that the product sections 186 will have different lengths. In order to maximize the number of product sections 186 obtained from a tube 24, the length (axial extent) of the scrap sections 180 and 182 is minimized. The scrap sections 180 and 182 have a length which is less than the length of the product sections 186.

Once the tube 24 has been cut, the tube cutter assembly 28 is moved back to the retracted condition of FIG. 10 by operation of the motors 172 and 174. Contemporaneously therewith, the over-center linkage assembly 84 is actuated to move the backup rollers 76, 78 and 80 back to the retracted condition of FIG. 10. The scrap sections 180 and 182 and product sections 186 remain in a telescopic relationship with the mandrel 60. Since the mandrel 60 is still in the retracted condition of FIG. 11, the mandrel drive assembly 152 is effective to rotate the mandrel 60 and sections 180,182 and 186 of the cut tube 24.

In accordance with one of the features of the present invention, the left (as viewed in FIG. 11) gripper assembly 70 is operated before the right gripper assembly 72. Thus, the open left gripper assembly 70 is moved forward toward the left scrap section 180 by a left gripper motor 192. When the left scrap section 180 is disposed between the lower and upper gripper fingers 102 and 104, operation of the left gripper motor 192 is interrupted.

The open left gripper assembly 70 is closed to grip the left scrap section 180 and hold it stationary. At this time, the stationary left scrap section 180 is disposed in a telescopic relationship with the rotating mandrel 60. At this time, the right gripper assembly 72 is in the open condition and does not grip the right scrap section 182. Therefore, the right scrap section 182 and product sections 186 rotate with the mandrel 60. By gripping the left scrap section 180 with the gripper assembly 70, the left scrap section is securely held and can not rotate with the mandrel 60.

When the left scrap section 180 is being gripped by the left gripper assembly 70, the left scrap section is stationary and does not rotate with the mandrel 60. Therefore, the rotating mandrel 60 slides along the inner side surface of the gripped scrap section 180. At this time, the right scrap section 182 is not gripped by the right gripper assembly 72. Therefore, the right scrap section 182 is still rotating with the mandrel 60.

After the left scrap section 180 has been securely gripped by the left gripper assembly 70, the mandrel motor 120 is operated to begin axial movement of the mandrel 60 from the retracted position of FIG. 11 toward the extended position of FIG. 9. At this time, the right gripper assembly 72 does not grip the right scrap section 182. Therefore, upon initial axial movement of the mandrel 60 toward the extended position, the product sections 186 and right scrap section 182 move rightward and rotate with the mandrel. When the rotating right scrap section 182 engages the stripper plate surface on the right side plate 144, rightward movement of the product sections 186 and scrap section 182 is interrupted. At this time, only the left scrap section 180 is held stationary by the left gripper assembly 70.

Engagement of the right scrap section 182 with the right (as viewed in FIG. 11) side plate 144 prevents continued rightward axial movement of the scrap section 182 with the rotating mandrel 60. Of course, blocking rightward axial movement of the scrap section 182 with the mandrel 60 is also effective to block rightward movement of the product sections 186 with the mandrel. At this time, the clutch plate 156 has moved out of engagement with the drive pulley 160. The mandrel 60 continues to rotate under the influence of its own inertia and the inertia of the clutch plate 156.

As the mandrel 60 continues to move rightward, the left end portion 138 of the mandrel moves out of a telescopic relationship with the product section 186 which is adjacent to the left scrap section 180. This releases the product section 186 which is adjacent to the left scrap section 180 so that this product section can drop downwardly, along a generally vertical path, under the influence of gravity. At this time, the left scrap section 180 is held stationary by the left gripper assembly 70 and does not move downwardly with the adjacent product section 186.

As the mandrel 60 continues to move rightward toward the extended position of FIG. 9, the mandrel sequentially moves out of a telescopic relationship with other product sections 186. As this is occurring, the open right gripper assembly 72 is moved forward toward the right scrap section 182 by a right gripper motor 194. When the right scrap section 182 is disposed between lower and upper gripper fingers 108 and 110, operation of the right gripper motor 194 is interrupted.

The right gripper assembly 72 is then operated from the open condition to a closed condition grip the right scrap section 182. Therefore, before the mandrel 60 is moved out of a telescopic relationship with the right scrap section 182, the right scrap section is held stationary by the right gripper assembly 72. The right gripper assembly 72 is operated to grip the right scrap section 182 after the mandrel 60 has moved out of engagement with some, but not all, of the product sections 186 and with the left scrap section 180.

As the mandrel 60 is moved out of a telescopic relationship with the product sections 186, the product sections move downwardly, along a generally vertical path, into the product receiving location 32 (FIG. 1). Since the scrap sections 180 and 182 are held by the left and right gripper assemblies 70 and 72, the scrap sections can not become mingled with the product sections 186. This results in the scrap sections 180 and 182 being held by the left and right gripper assemblies 70 and 72 in the manner illustrated in FIG. 12 after the product sections 186 have dropped downward into the product section receiving location or container 32 (FIG. 1). At this time (FIG. 12), the stationary scrap sections 180 and 182 are held in a coaxial relationship with the mandrel 60 by the gripper assemblies 70 and 72.

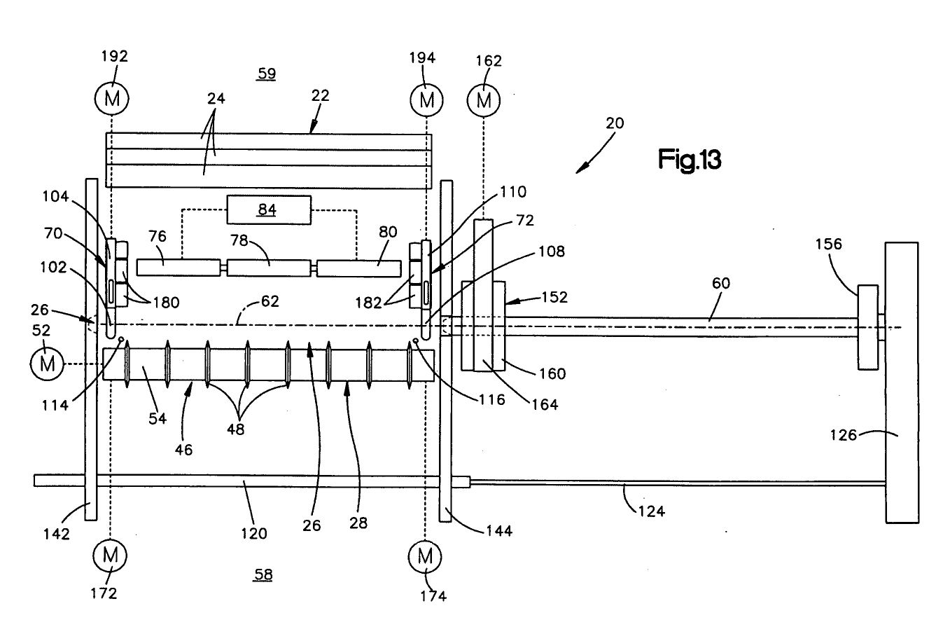

The left and right gripper positioning motors 192 and 194 (FIG. 12) are operated to move the left and right gripper assemblies 70 and 72 rearward, that is, toward the tubes 24 remaining in the tube supply assembly 22. As this occurs, the scrap sections 180 and 182 are moved out of alignment with the mandrel 60 (FIG. 12) to positions adjacent to the retracted backup rollers 76, 78, and 80 (FIG. 13). Operation of the left and right gripper positioning motors 192 and 194 moves the left and right gripper assemblies 70 and 72 and the scrap sections 180 and 182 away from the work station 26 along generally horizontal paths which extend transverse to the central axis 62 of the mandrel 60.

While the left and right gripper assemblies 70 and 72 are in their retracted positions and while the scrap sections 180 and 182 are held by the closed gripper assemblies (FIG. 13), a next succeeding tube 24 is fed from the tube feed or supply assembly 22 to the work station 26. As the next succeeding tube 24 enters the work station 26, the tube engages the left and right stop pins 114 and 116 in the manner illustrated in FIG. 9 for the proceeding tube 24. The next succeeding tube then falls downward onto the lower gripper fingers 102 and 104 (FIG. 13) of the left and right gripper assemblies 70 and 72 and is supported in axial alignment with the mandrel 60 in the manner previously explained herein. The foregoing process is then repeated until all of the tubes 24 have been cut into product sections 186 and scrap sections 180 and 182.

In the foregoing description, left and right gripper assemblies 70 and 72 have been utilized to grip left and right scrap sections 180 and 182. Although it is believed that it may be desired to form scrap sections at each of the end portions of a tube 24, it is contemplated that a scrap section may be formed at only one of the end portions of a tube 24. If this is done, only one of the gripper assemblies 70 and 72 would be required in the tube processing apparatus 20. A bracket or other support member may be provided to replace the long lower gripper finer 102 or 108 of the gripper assembly 70 or 72 to support a tube 24 before engagement of the tube by the mandrel 60.

In the embodiment of the invention illustrated in FIGS. 1-13, a tube feed or supply assembly 22 is utilized to sequentially feed tubes 24 to a work station 26 along a path extending perpendicular to a longitudinal central axis 62 of the mandrel 60. However, it is contemplated that work pieces may be moved into the work station 26 along a path which extends generally parallel to the longitudinal central axis 62 of the mandrel 60.

In the embodiment of the invention illustrated in FIGS. 1-13, the scrap sections 180 and 182 are received in receiving locations 34 and 36 which are offset rearwardly (FIGS. 1 and 2) of the product receiving location 32. It is contemplated that the scrap receiving locations 34 and 36 may be positioned differently relative to the product receiving location 32. For example, the scrap receiving locations 34 and 36 may be positioned in a side-by-side relationship with the product receiving location 32. Alternatively, the scrap receiving locations 34 and 36 may be positioned a substantial distance from the base 42 of the tube processing apparatus 20. If desired, a single scrap receiving location may be used for both scrap sections 180 and 182.

It is contemplated that it may be desired to use guides to direct scrap sections 180 from the left gripper assembly 70 to the receiving location 34. Similarly, guides may be used to direct scrap sections 182 from the right gripper assembly 72 to the receiving location 36. These guides may be formed of sheet metal and extend rearward and downward from the gripper assemblies 70 and 72 toward the receiving locations 34 and 36. If a single scrap receiving location is to be provided, the guides would direct scrap sections 180 from the left gripper assembly 70 and scrap sections 182 from the right gripper assembly 72 to the same scrap receiving location or container.

In the foregoing description, the open gripper assemblies 70 and 72 are moved forward by the gripper motors 192 and 194 after the tube 24 has been cut. However, it is contemplated that the open gripper assemblies 70 and 72 may be moved forward before the cutting of the tube 24 is completed. The open gripper assemblies 70 and 72 may be moved forward at any time when the tube 24 is in engagement with the lower gripper fingers 102 and 108. Moving the open gripper assemblies 70 and 72 forward before cutting of the tube 24 is completed would tend to reduce the cycle time.

### Gripper Assembly

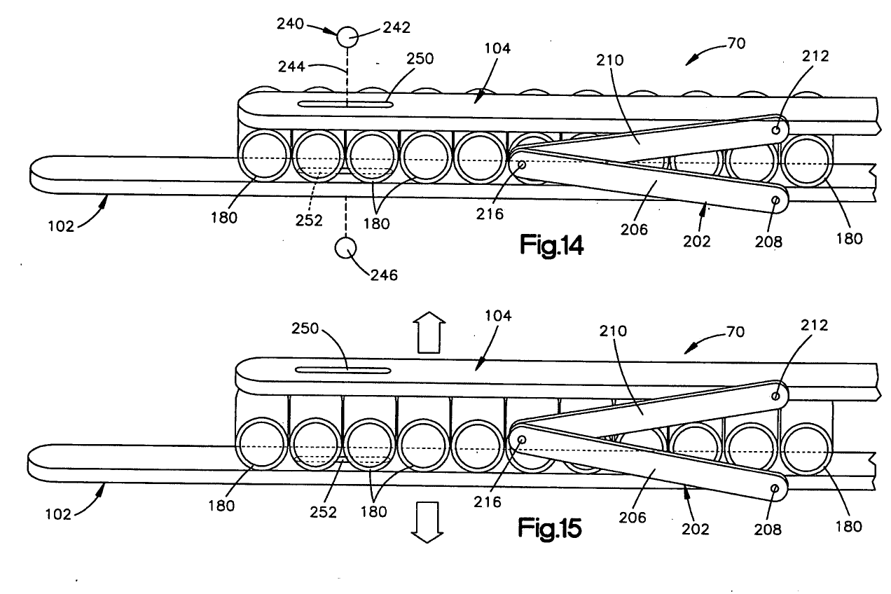

The left gripper assembly 70 includes parallel lower and upper gripper fingers 102 and 104 (FIGS. 4 and 14). The lower and upper gripper fingers 102 and 104 are interconnected by a linkage assembly 202. The linkage assembly 202 includes a lower link 206 (FIG. 14) which is pivotally connected at 208 to the lower gripper finger 102. Similarly, an upper link 210 is pivotally connected at 212 to the upper gripper finger 104.

The left (as viewed in FIG. 14) end portions of the lower link 206 and upper link 210 are interconnected at a pivot connection 216. The pivot connection 216 is pivotally connected to a horizontal actuator rod 222 (FIG. 4) which is connected with the gripper actuator motor 226. Although only a single linkage assembly 202 is illustrated schematically in FIG. 14, there are a pair of linkage assemblies, that is, the linkage assembly 202 and a second linkage assembly 230 (FIG. 4). Both linkage assemblies 202 and 230 are connected with the lower and upper gripper fingers 102 and 104 and with the actuator rod 222.

The gripper actuator motor 226 is operable to move the actuator rod 222 along a horizontal path. The linkage assemblies 202 and 230 are connected to the actuator rod 222 and maintain the upper and lower gripper fingers 102 and 104 in a horizontal parallel relationship during operation of the motor 226. If desired, the linkage assemblies 202 and 230 may have a different construction.

Upon operation of the gripper actuator motor 226, the actuator rod 222 operates the linkage assemblies 202 and 230 (FIG. 4) to actuate the upper and lower gripper fingers 102 and 104 between the closed condition illustrated schematically in FIG. 14 and the open condition illustrated schematically in FIG. 15. When the left gripper assembly 70 is in the closed condition illustrated in FIG. 14, the horizontal and parallel lower and upper gripper fingers 102 and 104 grip a linear array of left scrap sections 180 to hold the scrap sections against movement relative to the gripper fingers.

When the left gripper assembly 70 is in the open condition illustrated schematically in FIG. 15, the linear array of scrap sections 180 is supported by the horizontal lower gripper finger 102. The horizontal upper gripper finger 104 is spaced from the array of scrap sections 180. When the left gripper assembly 70 in is in the open condition (FIG. 15), it is ineffective to hold the left scrap sections 180 against movement relative to the lower gripper finger 102. When the left gripper assembly 70 is in the open condition of FIG. 5, the upper and lower gripper fingers are parallel to each other and are horizontal.

A detector assembly 240 (FIG. 14) is provided to detect the presence or absence of a scrap section 180 between the lower and upper gripper fingers 102 and 104. The detector assembly 240 includes a light source, that is, a laser 242 from which a beam 244 of light energy is directed toward a light detector or photo cell 246. The beam 244 of energy passes through a slot 250 in the upper gripper finger 104 and engages a scrap section 180. Therefore, the light beam 244 is not detected by the photo cell 246 when a scrap section 180 is disposed between the lower and upper gripper fingers 102 and 104 beneath the slot 250 as illustrated in FIG. 14.

In the absence of a scrap section 180 between the gripper fingers 102 and 104, the light beam 244 is directed from the light source 242 through the slot 250 in the upper gripper finger 104 and through a slot 252 in the lower gripper finger 102. When this occurs, the light beam 244 is detected by the photo cell 246 to indicate the absence of a scrap section 180 between the gripper fingers 102 and 104 at the slots 250 and 252. Although the light source 242 is a laser, other sources of a beam of energy may be used if desired.

Although only the left gripper assembly 70 has been illustrated in FIGS. 14-16, it should be understood that the right gripper assembly 72 (FIGS. 6 and 8-13) has the same construction as the left gripper assembly. However, the right gripper assembly 72 is a mirror image of the left gripper assembly 70. The right gripper assembly 72 includes linkage assemblies 254 and 256 (FIG. 6) which interconnects parallel lower and upper gripper fingers 108 and 110. A gripper actuator motor 258 is connected to the linkage assemblies 254 and 256 by a horizontal actuator rod 260. During operation of the motor 258, the linkage assemblies 254 and 256 maintain the lower and upper gripper fingers 108 and 110 in a horizontal parallel relationship.

In the illustrated embodiment of the invention, the left and right gripper assemblies 70 and 72 each hold a linear array of previously cut scrap sections 180 and 182 (FIG. 11). However, it is contemplated that the gripper assemblies 170 and 172 may be constructed so that they each hold only one scrap section 180 or 182. Alternatively, the gripper assemblies 70 and 72 may be constructed so that they do not hold any previously cut scrap sections 180 and 182.

### Gripper Assembly Operation

When a tube 24 is being positioned at the work station 26 in the manner illustrated schematically in FIGS. 8-10, when the tube 24 is being cut at the work station in the manner illustrated schematically FIG. 11, and when the left and right gripper assemblies 70 and 72 are holding scrap sections 180 and 182 in the manner illustrated schematically in FIGS. 12 and 13, the left and right gripper assemblies 70 and 72 are closed. The left and right gripper assemblies 70 and 72 are maintained in the closed condition, illustrated schematically in FIG. 14 for the left gripper assembly 70, by the gripper actuator motors 226 (FIG. 4) and 258 (FIG. 6) connected to the linkage assemblies 230 and 256.

The left and right gripper assemblies 70 and 72 are actuated to the open condition by the actuator motors 226 and 258. The gripper assemblies 70 and 72 are maintained in the open condition when the gripper assemblies are being moved from their retracted positions to their extended positions by the gripper positioning motors 192 and 194. This occurs after a tube 24 has been cut to form the scrap sections 180 and 182 and the product sections 186 (FIG. 11) by the tube cutter assembly 28. However, as was previously mentioned, the open gripper assemblies 70 and 72 may be moved to their extended positions at any time after the tube 24 has moved into engagement with the lower gripper fingers 102 and 108.

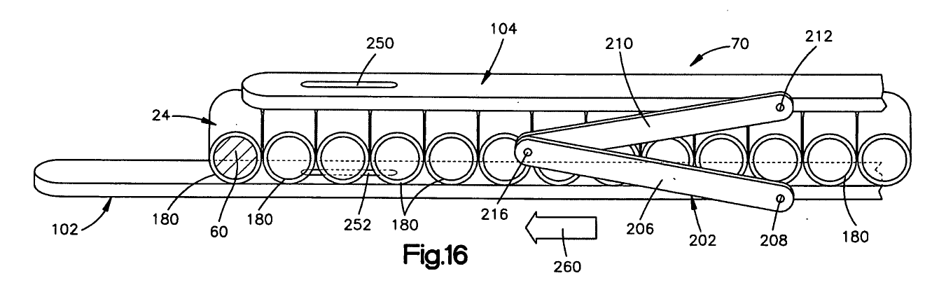

After the tube cutter assembly 28 has cut the tube to form the scrap sections 180 and 182 and product sections 186, the gripper actuator motors 226 and 258 (FIGS. 4 and 6) are simultaneously operated to move the gripper fingers 102 and 104 in the left gripper assembly and the gripper fingers 108 and 110 in the right gripper assembly to their open conditions (corresponding to the open condition of the left gripper fingers 102 and 104 in FIG. 15). At this time, the lower gripper fingers 102 and 108 in the left and right gripper assemblies 70 and 72 will be disposed beneath a cut tube 24 which is disposed in a telescopic relationship with the mandrel 60. The manner in which the lower gripper fingers 102 and 108 are disposed beneath the cut tube 24 is the same as is illustrated schematically in FIG. 16 for the gripper finger 102. During the cutting operation illustrated in FIG. 11, the gripper finger 102 in the left gripper assembly is disposed beneath the left scrap section 180. Similarly, the lower gripper finger 108 in the right gripper assembly 72 is beneath the right scrap section 182. At this time, the upper gripper fingers 104 and 110 are offset rearwardly from the scrap sections 180 and 182.

The gripper assemblies 70 and 72 are then operated to their open conditions by the gripper actuator motors 226 and 258. The gripper positioning motor 192 (FIG. 11) is then operated to move the open left gripper assembly 70 forwardly, that is, in a direction toward the mandrel 60. At this time, the mandrel 60 is in a telescopic relationship with and is rotating with the scrap sections 180 and 182.

As the open left gripper assembly 70 is moved forwardly, that is, in the direction indicated by the arrow 260 in FIG. 16, the left scrap section 180, which is in a telescopic relationship with the mandrel 60, applies force against the array of scrap sections 180 disposed between the open upper and lower gripper fingers 102 and 104. Since the cut tube 24 is disposed in a telescopic relationship with the mandrel 60, the portion of the tube forming the scrap section 180 (FIG. 16) can not move in a direction of the arrow 260. This results in the scrap section 180 of the cut tube 24 applying force against the array of scrap sections 180 cut from previous tubes and disposed between the open lower and upper gripper fingers 102 and 104. This force moves the array of previously cut scrap sections 180 toward the right (as viewed in FIG. 16) relative to the open gripper fingers 102 and 104.

As the array of previously cut scrap sections 180 moves rearwardly (toward the right as viewed in FIG. 16), the last (rearward most) scrap section 180 is pushed out of the left gripper assembly 70. This scrap section is conducted to the left scrap receiving location 34. Baffle plates are provided along opposite sides of the gripper assemblies 70 and 72 to block sidewise movement of the scrap sections 180 and 182.

It should be understood that a greater or lesser number of scrap sections 180 may be provided in the array of scrap sections held by the left gripper assembly 70. If desired, the array of scrap sections 180 held in the left gripper assembly 70 may be omitted so that there are no previously cut scrap sections held in the left gripper assembly. Alternatively, the number of previously cut scrap sections 180 held in the left gripper assembly may be reduced to one or two scrap sections.

When the left gripper assembly 70 has been moved forwardly, by the gripper motor 192 (FIG. 11) for a sufficient distance so that the scrap section 180 which is disposed in a telescopic relationship with the mandrel 60 is disposed between the lower and upper gripper fingers 102 and 104, the left gripper assembly is operated to the closed condition illustrated schematically in FIG. 14, by the gripper actuator motor 226. This results in the scrap section 180, which is disposed in a telescopic relationship with the mandrel 60 being gripped by the left gripper assembly 70. The gripped scrap section 180 is held stationary while the mandrel 60 continues to rotate.

The array of previously cut scrap sections 180 held by the left gripper assembly 70 is moved rearwardly, along the lower gripper finger 102 (FIG. 16), by force transmitted from the scrap section 180 which is disposed in a telescopic relationship with the mandrel 60. However, the array of previously cut scrap sections 180 held by the left gripper assembly 70 may be moved in a different manner if desired. For example, the array of previously cut scrap sections 180 may be moved rearwardly under the influence of force transmitted from the left gripper actuator motor 226.

Although only the left gripper assembly 70 is illustrated schematically in FIGS. 14-16, it should be understood that the right gripper assembly 72 operates in the same manner as the left gripper assembly. The open right gripper assembly 72 is moved forward, by operation of the right gripper motor 194. The open right gripper assembly 72 is moved forward after the left gripper assembly 70 has been operated to grip a left scrap section 180. Thus, the right gripper assembly 72 remains in the open condition after the left gripper assembly 70 has been operated to the closed condition. This results in the left gripper assembly 70 gripping the left scrap section 180 prior to gripping of the right scrap section 182 by the right gripper assembly 72.

While the left gripper assembly 70 is in the closed condition and while the right gripper assembly 72 is in the open condition, the mandrel motor 120 is operated to move the mandrel slide block toward the right (as viewed in FIG. 11). As this occurs, the leading end portion 138 of the mandrel 60 moves out of a telescopic relationship with the left scrap section 180. However, the left scrap section 180 is held in a coaxial relationship with the mandrel 60 by the left gripper assembly 70. Therefore, even though the mandrel 60 is moved out of a telescopic relationship with the left scrap section 180, the left scrap section is held in alignment with the mandrel 60.

Upon initial withdrawal movement of the mandrel 60 relative to the left scrap section 180, the product sections 186 and right scrap section 182 are moved toward the right with the mandrel. As this occurs, the right scrap section 182 moves into engagement with a stripper plate. In the illustrated embodiment of the invention, the stripper plate is formed by the right side plate 144. However, the stripper plate may be formed separately from the right side plate 144 if desired.

As the mandrel 60 continues to move toward the right away from the stationary left scrap section 180, the mandrel moves out of a telescopic relationship with the product section 186 which is next to the right scrap section 180. This releases the product section 186 which is disposed closest to the right scrap section 180 for downward movement toward the product receiving location 32 under the influence of gravity.

Continued rightward (as viewed in FIG. 11) movement of the mandrel 60 releases the next succeeding product section 186 for downward movement toward the product receiving location 32. As the mandrel 60 continues to move rightward (as viewed in FIG. 11) under the influence of mandrel drive motor 120, each of the product sections 186 is released in turn. The product sections 186 move downward into the product receiving location or container 32 in the same manner as is disclosed in the aforementioned U.S. Patent Publication No. 2004/0163512 Published Aug. 26, 2004. The disclosure in this patent publication has been and hereby is incorporated herein.

As the mandrel 60 is being withdrawn from the product sections 186, the right gripper assembly 72 (FIG. 16) is operated to a closed condition by the gripper actuator motor 258 (FIG. 6). When the right gripper assembly 72 is in the closed condition, it securely grips the right scrap section 182 (FIG. 11), in the same manner as was previously described in conjunction with the left gripper assembly 70 and left scrap section 180. Before the mandrel 60 has been withdrawn from all of the product sections 186, the closed right gripper assembly 72 firmly grips and holds the right scrap section 182.

When the mandrel 60 has been completely withdrawn from the right scrap section 182, the left and right scrap sections 180 and 182 are firmly held by the closed left and right gripper assemblies 70 and 72 in a coaxial relationship with the mandrel 60 (FIG. 12). At this time, all of the product sections 186 will have moved downwardly, away from the longitudinal central axis 62 of the mandrel 60. The closed gripper assemblies 70 and 72 and the arrays of scrap sections held by the gripper assemblies are then moved rearwardly, that is, away from the work station 26 by the gripper positioning motors 192 and 194, in the manner illustrated schematically in FIG. 13.

The gripper positioning motors 192 and 194 are simultaneously operated to move the closed left and right gripper assemblies rearward, away from the work station 26. The left and right gripper assemblies 70 and 72 are moved along generally horizontal paths which extend parallel to each other. This results in the scrap sections 180 and 182 being moved along paths which are spaced apart from generally vertical paths along which the product sections 186 move downward to the receiving location 32. Suitable baffle plates are provided to prevent movement of the scrap sections 180 and 182 out of there intended paths of movement.

During subsequent operation of the tube processing apparatus 20, the left and right gripper assemblies 70 and 72 are reciprocated between their extended and retracted positions in order to enable them to grip the scrap sections 180 and 182. When the gripper assemblies 70 and 72 are in the closed condition, the arrays of scrap sections 180 and 182 held by the gripper assemblies are firmly gripped. The arrays of scrap sections held by the gripper assemblies 70 and 72 are released only when the gripper assemblies are in the open condition (FIGS. 15 and 16). When the gripper assemblies 70 and 72 are in the open condition, baffle plates along opposite sides of the gripper assemblies maintain the scrap sections 180 and 182 in alignment with the gripper assemblies.

Each time the left gripper assembly 70 is operated to the open condition and moved forward, in the direction of the arrow 260 in FIG. 16, the array of scrap sections 180 held by the left gripper assembly 70 is moved rearwardly, that is, in the direction opposite to the arrow 260. The cut tube 24, which is in a telescopic relationship with the mandrel 60, presses against the array of scrap sections 180 to move the array of scrap sections. This forces the last scrap section 180 in the array of scrap sections out of the gripper assembly 70. This last scrap section 180 then moves downward into the scrap receiving location 34 (FIGS. 1 and 2). Similarly, the scrap sections 182 are sequentially forced from the right gripper assembly 72 and move downward into the right receiving location 36. Baffle plates are provided to direct the scrap sections 180 and 182 toward their respective receiving locations 34 and 36.

The generally vertical paths along which scrap sections 180 and 182 move downward into the scrap receiving locations 34 and 36 are horizontally spaced from the paths along which the product sections 186 drop downward from the end portion 138 of the mandrel 60. The paths along which the scrap sections 180 and 182 move are spaced rearward from the paths along which the product sections 186 move. Therefore, the scrap sections 180 and/or 182 can not be mixed with the product sections 186.

In the embodiment of the invention illustrated in FIGS. 1-16, the left and right gripper assemblies 70 and 72 are sequentially operated to grip scrap sections. Thus, the left gripper assembly 70 is operated first to grip the left scrap section 180. The right gripper assembly 72 is subsequently operated to grip the right scrap section 182. This is done to release the right scrap section and the product sections 186 for rightward movement toward the right side plate 144 as the mandrel 60 is withdrawn from the cut sections of a tube 24 (FIG. 11). However, if desired, the left and right gripper assemblies 70 and 72 may be simultaneously operated to grip the left and right scrap sections 180 and 182. If this is done, the right scrap section 182 would not move toward the right side plate 144 with the mandrel 60. Engagement of the rightward most product section 186 with the scrap section 182 would result in the scrap section 182 functioning as a stripper plate for the product sections 186 as the mandrel is withdrawn from the product sections.

Regardless of the order (time relationship) in which the left and right gripper assemblies 70 and 72 are operated to the closed condition, the left and right gripper assemblies hold the left and right scrap sections at the work station 26 after the product sections 186 had moved away from the work station (FIG. 12). In addition, the left and right gripper assemblies 70 and 72 hold some of the scrap sections 180 and 182 formed during the preceding cutting operations.

### Tube and Scrap Detection

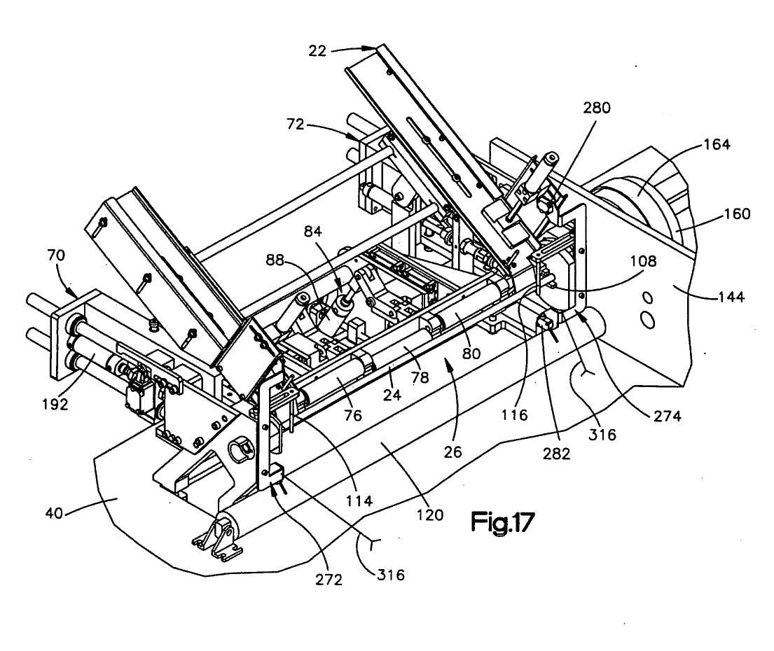

In accordance with another feature of the present invention, left and right detector assemblies 272 and 274 (FIG. 17) are provided to detect the presence or absence of a tube 24 from the work station 26. The left detector assembly 272 cooperates with the left gripper assembly 70 to detect the presence or absence of a scrap section 180 in the left gripper assembly. Similarly, the right detector assembly 274 cooperates with the right gripper assembly 72 to detect the presence or absence of a scrap section 182 in the right gripper assembly.

The manner in which the left and right detector assemblies 272 and 274 cooperate with the left and right gripper assemblies 70 and 72 to detect the presence or absence of scrap sections 180 and 182 is the same as was previously described in conjunction with the left gripper assembly 70 (FIG. 14). Thus, the left detector assembly 272 includes the light source 242 (FIG. 14) which directs a beam 244 of light energy through the slot 250 in the upper gripper finger 104. If a scrap section 180 is disposed between the light source 242 and light detector 246, the output from the light detector indicates that a scrap section is present. Similarly, if a scrap section 180 is not present between the light source 242 and the light detector 246, the output from the light detector indicates the lack of a scrap section.

Although the light source 242 may be either coherent or non-coherent light, in the illustrated embodiment of the invention, the light source 242 is a laser. Although the left detector assembly 272 utilizes a light source and light detector to detect the presence or absence of a scrap section in the left gripper assembly 70, it is contemplated that other known types of sensors may be utilized if desired. Known energy sources may be substituted for the light source 242 to direct beams of energy other than light to a suitable detector assembly 272.

The right detector assembly 274 cooperates with the right gripper assembly 72 to detect the presence or absence of a scrap section 182 in the right gripper assembly. Although only the construction of the left gripper assembly 70 is illustrated schematically in FIG. 16, it should be understood that the right gripper assembly 72 has the same construction as the left gripper assembly 70.

The right detector assembly 274 is also effective to detect the presence or absence of a tube 24 at the work station 26. The right detector assembly 274 includes an energy source, that is, a light source 280 (FIG. 17). The light energy source 280 directs a beam of light through the work station 26 to a light detector 282. If a tube 24 is present at the work station 26, the beam of light from the right source 280 is blocked and the output from the light detector 282 indicates that the tube is present. However, in the absence of a tube 24 at the work station 26, the beam of light from the source 280 is not blocked and the output from the light detector 282 indicates the presence of a tube 24 at the work station 26.

The left detector assembly 272 has the same construction as the right detector assembly 274 and detects the presence or absence of a tube 24 in the same manner as previously discussed in conjunction with the right detector assembly 274. By having opposite end portions of a tube 24 detected by the left and right detector assemblies 272 and 274, the skewing of a tube relative to the work station 26 can be detected.

In accordance with another feature of the invention, an indicator assembly 290 (FIG. 1) is provided to indicate whether or not a tube 24 is disposed at the work station. In addition, the indicator assembly 290 indicates whether or not a scrap section 180 is disposed in the left gripper assembly 70 and whether or not a scrap section 182 is disposed in the right gripper assembly 72. When the left and/or right detector assemblies 272 and 274 (FIG. 17) detect the absence or skewing of a tube 24 at the work station 26, an indicator section 294 (FIG. 1) of the indicator assembly 290 is illuminated to provide a visual indication to an operator of the tube processing apparatus 20 that a tube 24 is not at or in the desired orientation relative to the work station 26.

Similarly, if the left and/or right detector assemblies 272 and 274 (FIG. 17) detect the absence of a scrap section in either one or both of the two gripper assemblies 70 and 72, an indicator section 296 (FIG. 1) of the indicator assembly 290 is illuminated to provide an indication to the operator of the tube processing apparatus. If both a tube 24 is missing from the work station 26 and one or more scrap sections 180 or 182 are missing from one or more of the gripper assemblies 70 or 72, both indicator sections 294 and 296 of the indicator assembly 290 are energized to provide a signal to the operator of the tube processing apparatus 20. Although the indicator assembly 290 only provides for a visual signal by energization of the indicator sections 294 and/or 296, it is contemplated that an audible signal may be provided in addition to or in place of a visual signal.

### Controls

A controller 302 (FIG. 1) is provided to control operation of the tube processing apparatus. The controller 302 controls operation of the various motors in the tube processing apparatus 20. The motors in the tube cutter assembly 28 are connected with the controller by conductors which have been indicated at 306 in FIG. 1.

Thus, the motor 52 (FIGS. 1 and 8) which rotates the spindle 52 and cutting knives 48 and the two motors 172 and 174 which move the rotating knives into and out of engagement with a tube 24 at the work station 26 are connected with the controller 302 by the conductors 306. The mandrel drive motor 162 and the mandrel positioning motor 120 (FIG. 8) are connected with the controller 302 by leads indicated at 308 in FIG. 1. The motors 192 and 194 (FIG. 8) which move the grippers toward and away from the work station 26 are connected with the controller 302 over leads indicated at 310 in FIG. 1. The gripper actuator motors 226 and 258 (FIGS. 4 and 6) for the left and right gripper assemblies 70 and 72 are connected with the controller 302 by conductors indicated at 312 in FIG. 1.

The motors 88 and 90 (FIG. 7) in the over-center linkage assembly 84 are connected with the controller 302 by conductors indicated at 314 in FIG. 1. The left and right detector assemblies 272 and 274 (FIG. 17) and the indicator assembly 290 (FIG. 1) are connected with the controller 302 by conductors 316. Various other control functions are connected with the controller 302 by various conductors which have been indicated schematically at 318 in FIG. 1.

### CONCLUSION

The present invention relates to a new and improved method and apparatus for processing tubes 24. When a tube 24 is to be processed, the tube is moved into a work station 26. The tube 24 is cut into a plurality of sections 180,182 and 186 (FIG. 11) while the tube is at the work station.

The sections into which the tube 24 is cut may include one or more scrap sections 180 and/or 182. The scrap section or sections may advantageously be moved to a scrap receiving location or locations 34 and/or 36. Other sections of the tube, that is, product sections 186, may be moved to a product receiving location 32 which is separate from a scrap receiving location 34 or 36.

In accordance with one of the features of the present invention, a scrap section 180 or 182 may be gripped with a gripper 70 or 72. This may be done while the scrap section 180 or 182 and mandrel are in a telescopic relationship. Thereafter, the mandrel 60 and scrap section 180 or 182 are moved out of a telescopic relationship. The scrap section 180 or 182 may be moved away from the mandrel 60 along a path which extends transverse to a central axis 62 of the mandrel while continuing to grip the scrap section.

In accordance with another feature of the invention, before the tube 24 is cut, the tube may be supported at the work station 26 by one or more grippers 70 and/or 72. After the tube 24 is cut, a scrap section 180 or 182 of the tube may be gripped with a gripper 70 or 72 while the mandrel 60 is in a telescopic relationship with the scrap section. The scrap section 180 or 182 and gripper 70 or 72 may be moved away from the work station 26 after the scrap section and mandrel 60 have moved out of a telescopic relationship.

In accordance with another feature of the invention, when a second tube 24 is moved to the work station 26 and is cut to form a plurality of product sections 186 and one or more scrap sections 180 and/or 182, a gripper 70 or 72 may be moved toward a scrap section 180 or 182 formed by the second tube 24 while the gripper 70 or 72 holds a scrap section formed by the first tube. The scrap section 180 or 182 formed by the first tube 24 may be moved relative to the gripper 70 or 72 as the gripper moves toward the scrap section formed by the second tube. The scrap section 70 or 72 formed by the second tube 24 may be gripped by the gripper 70 or 72 and moved away from the mandrel 60 while the gripper holds the scrap section formed by the first tube.

The present invention includes a plurality of different features which have been described in combination with each other. However, it is contemplated that each of the features may be utilized separately or may be combined in a different manner with one or more of the other features of the invention. It is also contemplated that one or more of the features of the invention may be used separately or in combination with features from the prior art.

For example, only one scrap section 180 or 182 may be formed during cutting of the tube 24. If this is to be done, one of the gripper assemblies 70 or 72 may be omitted or rendered inactive. As another example, the backup rollers 76-80 may be eliminated. As still another example, a tube 24 may be supported at the work station 26 by devices other than the gripper assemblies 70 and/or 72. As a further example, the gripper assemblies 70 and/or 72 may be constructed so as to eliminate the holding of previously cut scrap sections 180 and/or 182.

Having described the invention, the following is claimed:

1. A method of processing tubes, said method comprising the steps of moving a mandrel and a tube into a telescopic relationship, cutting the tube to form a plurality of product sections and at least one scrap section while rotating the tube and mandrel about a central axis of the mandrel and while the tube and mandrel are in a telescopic relationship, gripping the scrap section while the scrap section and mandrel are in a telescopic relationship, thereafter, moving the mandrel and scrap section out of a telescopic relationship while continuing to grip the scrap section, and receiving the plurality of product sections at a receiving location.

2. A method as set forth in claim 1 wherein said step of gripping the scrap section includes transmitting force from the scrap section to a previously formed scrap section to move the previously formed scrap section relative to a gripper.

3. A method as set forth in claim 1 further including the step of moving the scrap section away from the central axis of the mandrel along a path which extends transverse to the central axis of the mandrel while continuing to grip the scrap section.

4. A method as set forth in claim 1 further including the step of pressing a plurality of backup rollers against the tube during performance of at least a portion of said step of cutting the tube.

5. A method as set forth in claim 1 further including the steps of sensing whether or not a scrap section is being gripped, and providing a first output signal in response to sensing that a scrap section is not being gripped.

6. A method as set forth in claim 5 further including the steps of sensing whether or not a tube is at a work station, and providing a second output signal in response to sensing that a tube is not at the work station.

7. A method as set forth in claim 6 further including the steps of providing a first visual indication in response to the first output signal and providing a second visual indication in response to the second output signal, said first visual indication being different than said second visual indication.

8. A method as set forth in claim 1 wherein said step of gripping the scrap section includes holding the scrap section against rotation while continuing to rotate the mandrel.

9. A method as set forth in 1 wherein said step of moving the mandrel and scrap section out of a telescopic relationship is performed while the plurality of product sections are disposed in a telescopic relationship with the mandrel.

10. A method as set forth in claim 1 wherein said step of moving the mandrel and scrap section out of a telescopic relationship is performed after moving the mandrel and product sections out of a telescopic relationship.

11. A method as set forth in claim 1 further including the step of gripping a scrap section from a preceding tube while cutting the tube which is disposed in a telescopic relationship with the mandrel.

12. A method as set forth in claim 1 further including the step of at least partially supporting the tube at the work station with a gripper prior to performing said step of moving the mandrel and tube into a telescopic relationship, said step of gripping the scrap section includes gripping the scrap section with the gripper.

13. A method as set forth in claim 1 wherein said step of gripping the scrap section includes engaging the scrap section with first and second gripper fingers, said method further includes at least partially supporting the tube at the work station with the first gripper finger prior to performing said step of gripping the scrap section.

14. A method as set forth in claim 13 wherein the first gripper finger has a length which is greater than the length of said second gripper finger, said step of at least partially supporting the tube at the work station includes engaging the tube with a portion of the first gripper finger.

15. A method as set forth in claim 1 wherein said step of gripping the scrap section includes engaging the scrap section with first and second gripper fingers, said method further includes transmitting a beam of energy through at least one of the gripper fingers to detect whether or not a scrap section is disposed between the gripper fingers.

16. A method as set forth in claim 1 further including the step of holding the scrap section in axial alignment with the mandrel after the product sections have moved out of axial alignment with the mandrel and after the mandrel and scrap section have moved out of a telescopic relationship

17. A method as set forth in claim 1 wherein said step of cutting the tube includes forming a first scrap section at a first end portion of the tube and forming a second scrap section at a second end portion of the tube.

18. A method as set forth in claim 17 further including the step of holding the first and second scrap sections in axial alignment with the mandrel after the product sections have moved out of axial alignment with the mandrel.

19. A method as set forth in claim 1 wherein said step of gripping the scrap section includes gripping the scrap section with a gripper, said method further includes moving the mandrel and a second tube into a telescopic relationship, cutting the second tube to form a second plurality of product sections and at least a second scrap section while rotating the second tube and mandrel about the central axis of the mandrel and while the second tube and mandrel are in a telescopic relationship, moving the scrap section formed from the tube preceding the second tube and the gripper toward the scrap section formed from the second tube, moving the scrap section formed from the tube preceding the second tube relative to the gripper under the influence of force transmitted from the scrap section formed from the second tube as the gripper moves toward the scrap section formed from the second tube, and gripping the scrap section formed from the second tube with the gripper while the scrap section formed from the tube preceding the second tube is held by the gripper.

20. A method of processing tubes, said method comprising the steps of moving a first tube to a work station, moving a mandrel into a telescopic relationship with the first tube while the first tube is at the work station, cutting the first tube to form a first plurality of product sections and a first scrap section while the first tube and a mandrel are in a telescopic relationship, gripping the first scrap section with a first gripper while the first scrap section is at the work station in a telescopic relationship with the mandrel, moving the mandrel and first scrap section out of a telescopic relationship while the first scrap section is gripped by the first gripper, moving the first gripper and first scrap section away from the work station, moving a second tube to the work station, moving the mandrel into a telescopic relationship with the second tube while the second tube is at the work station, cutting the second tube to form a second plurality of product sections and a second scrap section while the second tube and mandrel are in a telescopic relationship, moving the first scrap section and first gripper toward the second scrap section, moving the first scrap section relative to the first gripper as the first gripper moves toward the second scrap section, gripping the second scrap section with the first gripper while the second scrap section is at the work station in a telescopic relationship with the mandrel and while the first scrap section is held by the first gripper, moving the mandrel and second scrap section out of a telescopic relationship while the second scrap section is gripped by the first gripper and while the first scrap section is held by the first gripper, and receiving the first and second pluralities of product sections at a product receiving location.

21. A method as set forth in claim 20 wherein said step of moving the first scrap section relative to the first gripper as the first gripper moves toward the second scrap section includes engaging the second scrap section with the first scrap section and moving the first scrap section relative to the first gripper under the influence of force transmitted from the second scrap section to the first scrap section.

22. A method as set forth in claim 20 wherein the first gripper is operable between an open condition in which the first gripper is ineffective to grip a scrap section and a closed condition in which the first gripper is effective to grip a scrap section, said step of gripping the first scrap section includes operating the first gripper from the open condition to the closed condition, said steps of moving the mandrel and first scrap section out of a telescopic relationship and moving the first gripper and first scrap section away from the work station are at least partially performed with said first gripper in the closed condition, said step of moving the first scrap section relative to the first gripper is at least partially performed with the first gripper in the open condition, said step of gripping the second scrap section with the first gripper includes operating the first gripper form the open condition to the closed condition.

23. A method as set forth in claim 22 wherein said step operating the first gripper from the open condition to the closed condition to grip the first scrap section includes engaging a first portion of an outer side surface of the first scrap section with a first gripper finger and engaging a second portion of the outer side surface of the first scrap section with a second gripper finger.

24. A method as set forth in claim 20 further including the step of rotating the mandrel and first tube about a longitudinal central axis of the first tube during performance of at least a portion of said step of cutting the first tube, said step of gripping the first scrap section includes stopping rotation of the first scrap section while the mandrel continues to rotate.

25. A method as set forth in claim 20 wherein said step of cutting the first tube includes forming a third scrap section at an end portion of the first tube opposite from an end portion of the first tube at which the first scrap section is formed, gripping the third scrap section with a second gripper while the third scrap section is at the work station in a telescopic relationship with the mandrel, moving the mandrel and the third scrap section out of a telescopic relationship while the third scrap section is gripped by the second gripper, moving the second gripper and third scrap section away from the work station, said step of cutting the second tube includes forming a fourth scrap section at an end portion of the second tube opposite from an end portion of the second tube at which the second scrap section is formed, moving the third scrap section and second gripper toward the fourth scrap section, moving the third scrap section relative to the second gripper as the second griper moves toward the fourth scrap section, gripping the fourth scrap section with the second gripper while the fourth scrap section is at the work station in a telescopic relationship with the mandrel and while the third scrap section is held by the second gripper, moving the mandrel and fourth scrap section out of a telescopic relationship while the fourth scrap section is gripped by the second gripper and while the third scrap section is held by the second gripper.

26. A method as set forth in claim 25 wherein said step of moving the first scrap section relative to the first gripper as the first gripper moves toward the second scrap section includes engaging the second scrap section with the first scrap section and moving the first scrap section relative to the first gripper under the influence of force transmitted from the second scrap section to the first scrap section.

27. A method as set forth in claim 25 further including the steps of pressing a plurality of backup rollers against the first tube during performance of at least a portion of said step of cutting the first tube and pressing the backup rollers against the second tube during performance of at least a portion of said step of cutting the second tube.

28. A method as set forth in claim 25 wherein said step of gripping the third scrap section with the second gripper is performed after performing said step of moving the mandrel and first scrap section out of a telescopic relationship, said step of gripping the fourth scrap section with the second gripper is performed after performing said step of moving the mandrel and second scrap section out of a telescopic relationship.

29. A method as set forth in claim 20 further including the steps of at least partially supporting the first tube at the work station with the first gripper prior to performing said step of moving the mandrel into a telescopic relationship with the first tube, and at least partially supporting the second tube at the work station with the first gripper prior to performing said step of moving the mandrel into a telescopic relationship with the second tube.

30. A method of processing tubes, said method comprising the steps of moving a first tube to a work station, moving a mandrel and the first tube into a telescopic relationship while the first tube is at the work station, rotating the first tube at the work station under influence of force transmitted to the first tube from the mandrel, rotating a plurality of knives about an axis spaced from and extending parallel to the longitudinal central axis of the mandrel, moving the plurality of rotating knives into engagement with the first tube while the first tube and mandrel rotate about the longitudinal central axis of the mandrel, cutting the first tube at the work station with the rotating knives to form a plurality of product sections and a first scrap section while the first tube and mandrel rotate about the central axis of the mandrel, gripping the first scrap section with a first gripper while the first scrap section and mandrel are in a telescopic relationship, moving the plurality of product sections in a first direction along a first path extending from the work station to a receiving location, and moving the first scrap section from the work station in a second direction along a portion of a second path which extends transverse to the first path, said step of moving the first scrap section from the work station in a second direction being at least partially performed with the first scrap section held by the first gripper.

31. A method as set forth in claim 30 further including the steps of engaging the first tube with a plurality of backup rollers having central axes extending parallel to the longitudinal central axis of the mandrel and rotating the backup rollers under the influence of force transmitted from the first tube to the backup rollers while the first tube is engaged by the backup rollers.

32. A method as set forth in claim 30 wherein said step of cutting the first tube includes forming a second scrap section, said method further includes gripping the second scrap section with a second gripper while the second scrap section and mandrel are in a telescopic relationship, and moving the second scrap section away from the work station along a portion of a third path which extends transverse to the first path, said step of moving the second scrap section from the work station is at least partially performed with the second scrap section held by the second gripper.

33. A mandrel as set forth in claim 30 further including the step of moving a second tube to the work station, moving the mandrel and the second tube into a telescopic relationship while rotating the mandrel and while the second tube is at the work station, rotating the second tube at the work station under the influence of force transmitted to the second tube from the mandrel, moving the plurality of rotating knives into engagement with the second tube while the second tube and mandrel rotate about the longitudinal central axis of the mandrel and while the backup rollers engage the second tube, transmitting force from the rotating knives to the second tube, cutting the second tube at the work station with the rotating knives to form a second plurality of product sections and a second scrap section while the second tube and mandrel rotate about the central axis of the mandrel, moving the first scrap section and first gripper along the second path toward the second scrap section, moving the first scrap section relative to the first gripper as the first gripper moves toward the second scrap section, gripping the second scrap section with the first gripper while the second scrap section is at the work station in a telescopic relationship with the mandrel and while the first scrap section is held by the first gripper, moving the second product sections in the first direction along the first path, and moving the second scrap section in the second direction along the second path, said step of moving the second scrap section in the second direction being at least partially performed with the second scrap section held by the first gripper.

34. A method of processing tubes, said method comprising the steps of moving a first tube to a work station, moving a mandrel and the first tube into a telescopic relationship, rotating a plurality of knives about an axis extending parallel to the central axis of the mandrel, cutting the first tube at the work station with the rotating knives to form a plurality of product sections and a plurality of scrap sections, gripping a first scrap section with a first gripper while the first scrap section and mandrel are in a telescopic relationship, gripping a second scrap section with a second gripper while the second scrap section and mandrel are in a telescopic relationship, moving the mandrel out of a telescopic relationship with the first and second scrap sections and with the plurality of product sections, moving the plurality of product sections away from the work station along a first path to a receiving location, moving the first gripper and first scrap section away from the work station along a second path which is at least partially spaced from the first path, and moving the second gripper and second scrap section away from the work station along a third path which is at least partially spaced from the first path.

35. A method as set forth in claim 34 wherein said step of gripping the second scrap section with the second gripper is performed after gripping the first scrap section with the first gripper.

36. A method as set forth in claim 34 wherein said step of gripping the second scrap section with the second gripper is performed after gripping the first scrap section with the first gripper and after moving the mandrel out of a telescopic relationship with the first scrap section.

37. A method as set forth in claim 34 wherein said step of gripping the second scrap section with the second gripper is performed after gripping the first scrap section with the first gripper and after moving the mandrel out of a telescopic relationship with the first scrap section and with at least some of said product sections.

38. A method as set forth in claim 34 further including the step of moving a second tube to the work station, moving the mandrel and second tube into a telescopic relationship, cutting the second tube at the work station with the rotating knives to form a second plurality of product sections and third and fourth scrap sections while rotating the knives and while rotating the second tube, moving the first scrap section and first gripper toward the third scrap section, moving the first scrap section relative to the first gripper as the first gripper moves toward the third scrap section, gripping the third scrap section with the first gripper while the third scrap section and mandrel are in a telescopic relationship, moving the second scrap section and second gripper toward the fourth scrap section, moving the second scrap section relative to the second gripper as the second gripper moves toward the fourth scrap section, gripping the fourth scrap section with the second gripper while the fourth scrap section and mandrel are in a telescopic relationship, moving the second plurality of product sections away from the work station along the second path to the receiving location, moving the first gripper and third scrap section away from the work station along the second path, and moving the second gripper and fourth scrap section away from the work station along the third path.

39. A method as set forth in claim 34 further including the steps of sensing whether or not a scrap section is held by the first gripper, providing an output signal in response to sensing that a scrap section is not held by the first gripper, sensing whether or not a scrap section is held by the second gripper and providing an output signal in response to sensing that a scrap section is not held by the second gripper.

40. A method as set forth in claim 34 further including the step of at least partially supporting the first tube with the first and second grippers prior to performing said step of moving the mandrel and first tube into a telescopic relationship.

41. A method as set forth in claim 34 wherein said steps of gripping the first scrap section with the first gripper includes engaging the first scrap section with first and second gripper fingers, transmitting a beam of energy through at least one of the first and second gripper fingers to detect whether or not a scrap section is disposed between the first and second gripper fingers, said step gripping the second scrap section with the second gripper includes engaging the second scrap section with third and fourth gripper fingers, and transmitting a beam of energy through at least one of the third and fourth gripper fingers to detect whether or not a scrap section is disposed between the third and fourth gripper fingers.

42. A method as set forth in claim 34 further including the step of maintaining the first and second scrap sections in axial alignment with the mandrel after the plurality of product sections have moved out of axial alignment with the mandrel.
